(19) United States
(12) Patent Application Publication
(10) Pub. No.: US 2010/0201499 A1
(43) Pub. Date: Aug. 12, 2010

(54) METHOD OF CONNECTING A DEVICE TO A NETWORK

(75) Inventors: Timothy James Wilson, Oxford (GB); Victor Poznanski, Oxford (GB); Andrew Kay, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(73) Assignee: SHARP KABUSHIKI KAISHA, Osaka-shi (JP)

(21) Appl. No.: 12/516,691

(22) PCT Filed: Nov. 2, 2007
(86) PCT No.: PCT/JP2007/071747

§ 371 Date: Jan. 8, 2010

(30) Foreign Application Priority Data
Nov. 30, 2006 (GB) 0623888.5

(51) Int. Cl. G08B 9/00

(52) U.S. Cl. 340/286.02

(57) ABSTRACT

A method is provided of connecting a device (101) having a limited user interface to a predetermined one of a plurality of available networks. The method comprises trying each of the available networks in turn from the device until an indication (160) is provided from a component (150) of the predetermined network in response to said trying that confirms that the predetermined network has been reached. In response to such an indication (160) being provided, the device (101) is connected to the predetermined network if not already so connected as part of said trying.

### TECHNICAL FIELD

The present invention relates to a method of connecting a device to a network.

### BACKGROUND ART

A common scenario in a networked home is one in which a user wishes to register a ‘simple’ appliance (one with no complex user interfaces) on an existing wireless, powerline or other type of network. Example such appliances include: a doorbell button, an intruder sensor, and a blood pressure monitor. A typical scenario is illustrated in FIG. 1 of the accompanying drawings, showing a washing machine 1, desktop personal computers 2 and 3, a printer 4, a Personal Digital Assistant (PDA) 5, and a laptop 6 in communication over a wireless network via a network device (an access point 7), and onward to the Internet 8. In this example, a ‘simple’ appliance or device might be the washing machine 1 or the printer 4.

It is becoming increasingly common that several networks are within range of a home environment, for example those networks emanating and controlled from neighbours' houses, and this is particularly so where people live in close quarters within the same building. The ‘simple’ appliance may be capable of joining more than one of the networks within range, but there would usually be a particular one of these that the user intends the appliance to join.

This scenario is illustrated in FIG. 2 of the accompanying drawings, which shows two wireless access points 52A and 52B in communication with existing devices 50A and 50B on respective networks A and B. As illustrated, there is an area of potential overlap between networks A and B, such that a new device 11 within that area of overlap is able to connect to both network A and B.

Since the intention as to which network is to be joined resides with the user, some mechanism is required by which the user may inform the appliance of the correct network. This is easily achieved for devices having a relatively rich user interface such as a screen (for example, with Personal Digital Assistants, telephone handsets, microwave ovens, and so on), since the appliance can display a list of network names from which the user can select.

However, more ‘simple’ appliances with no display typically require a temporary connection to a more sophisticated device, for example a Universal Serial Bus (USB) connection to a Personal Computer (PC), to receive network information. However, this is not ideal for many reasons: it requires the user to own a suitable host device; it is complicated; it is time-consuming; and it requires the appliance to be physically close to the host device (which may not be practicable for a large item such as a washing machine).

Another approach would be to use a portable token, such as a smart card, to copy the network settings to the appliance. However, this is likely to require additional communication hardware to be built into the appliance. It also demands that the user be able to find the appropriately-initialized token every time a new appliance is to be added to a network.

Another approach would be to require the user to open a time-limited ‘registration period’ from the desired network, during which the appliance is able to connect to that network.

Other approaches are described in U.S. Pat. No. 6,799,038 “Method and apparatus for wireless network selection”, U.S. 2004/0168081 “Apparatus and method simplifying an encrypted network” and U.S. 2005/0113943 “Wireless network controller communicating with household appliances”.

Therefore, existing wireless devices usually fall into one of the following categories: (a) they would have a sufficiently rich interface that the user can select the correct wireless network directly from the device (consider connecting a laptop to an 802.11 network, for example); (b) they would choose the first available open network (e.g. Windows® XP 802.11 networking); (c) they would utilise a physical token to transfer network settings to the device; (d) they would use a proprietary networking protocol (or modification of a standard protocol)—this includes mechanisms such as requiring the user to press a button on the network controller to put it temporarily into a ‘find new device’ mode, detectable by the device; or (e) they simply would not work if more than one network is available to them

It is desirable to address the above problem of providing a ‘simple’ device with a means of connecting to a particular network.

### DISCLOSURE OF INVENTION

According to a first aspect of the present invention, there is provided a method of connecting a device having a limited user interface to a predetermined one of a plurality of available networks, comprising trying each of the available networks in turn from the device until an indication is provided from a component of the predetermined network in response to said trying that confirms that the predetermined network has been reached; and, in response to such an indication being provided, connecting the device to the predetermined network if not already so connected as part of said trying.

Trying each of the available networks in turn from the device may comprise connecting or attempting to connect the device to each of the available networks in turn.

Trying each of the available networks in turn from the device may comprise polling each network in turn.

The method may comprise automatically moving on to the next network in turn unless the device is informed, within a predetermined time period or before a predetermined event occurs, that such an indication has been provided.

The predetermined time period may be measured relative to the commencement of said trying.

The predetermined event may be a user action performed for example at the device.

The method may comprise providing interface means at the device for allowing a user to inform the device that such an indication has been provided.

The method may comprise providing interface means at the device for allowing the user to move the device on to the next network in turn.

The interface means may comprise a sliding type switch.

The interface means may comprise a push-button type switch.

The method may comprise providing means at the device for receiving a signal over a network informing the device that such an indication has been provided.

The method may comprise receiving such a signal over the predetermined network.

The method may comprise providing interface means at a component of the predetermined network for allowing a user to confirm that such an indication has been provided, and, in response to such user confirmation, sending such a signal to the device.

The method may comprise registering the device with the predetermined network.

The method may comprise registering the device with the predetermined network only when such user confirmation has been provided.

Such an indication may provide an identification of the device, thereby confirming that the predetermined network has been reached by the device.

Such an indication may comprise a visual indication.

Such an indication may comprise an audio indication.

Such an indication may comprise an electronic indication, and the method may comprise providing a secondary indication in response to receipt of such an electronic indication that confirms that the predetermined network has been reached.

The method may comprise providing such a secondary indication at the device.

The user interface of the device may be limited to the extent that it does not allow direct selection by a user of the device of the predetermined network from a list of the available networks.

The user interface may be that which is presented to the user specifically in relation to the connecting of the device. For example, a device may be capable of providing a rich and complex user interface, but may choose to present only a limited user interface to the user for the purpose of connecting the device to a network.

The user interface may comprise a physical interface.

The user interface may comprise a graphical interface.

The predetermined network may be a wireless or a powerline network.

According to a second aspect of the present invention, there is provided a device having the ability to connect to a predetermined one of a plurality of available networks despite having a limited user interface, comprising means for trying each of the available networks in turn until an indication is provided from a component of the predetermined network in response to said trying that confirms that the predetermined network has been reached; and, in response to the indication being provided, connecting the device to the predetermined network if not already connected as part of said trying.

According to a third aspect of the present invention, there is provided a program for controlling an apparatus to perform a method according to the first aspect of the present invention, or which, when loaded into an apparatus, causes the apparatus to become a device according to the second aspect of the present invention.

The program may be carried on a carrier medium.

The carrier medium may be a storage medium.

The carrier medium may be a transmission medium.

According to a fourth aspect of the present invention, there is provided an apparatus programmed by a program according to the third aspect of the present invention.

According to a fifth aspect of the present invention, there is provided a storage medium containing a program according to the third aspect of the present invention.

### BRIEF DESCRIPTION OF DRAWINGS

FIG. 1, discussed hereinbefore, illustrates a typical wireless network having a variety of different types of connected device;

FIG. 2, also discussed hereinbefore, illustrates a situation where two different networks have an area of overlap in which a new device is able to connect to both networks;

FIG. 3 is a block diagram illustrating a system according to a first embodiment of the present invention;

FIG. 4 is a flowchart illustrating operation of a part of the first embodiment of the present invention;

FIG. 5 is a block diagram illustrating a system according to a second embodiment of the present invention;

FIG. 6 is a flowchart illustrating operation of a part of the second embodiment of the present invention;

FIG. 7 is a block diagram illustrating a system according to a third embodiment of the present invention;

FIG. 8 is a flowchart illustrating operation of a part of the third embodiment of the present invention;

FIG. 9 is a flowchart illustrating operation of another part of the third to fifth embodiments of the present invention;

FIG. 10 is a block diagram illustrating a system according to a fourth embodiment of the present invention;

FIG. 11 is a flowchart illustrating operation of a part of the fourth embodiment of the present invention;

FIG. 12 is a block diagram illustrating a system according to a fifth embodiment of the present invention; and

FIG. 13 is a flowchart illustrating operation of a part of the fifth embodiment of the present invention.

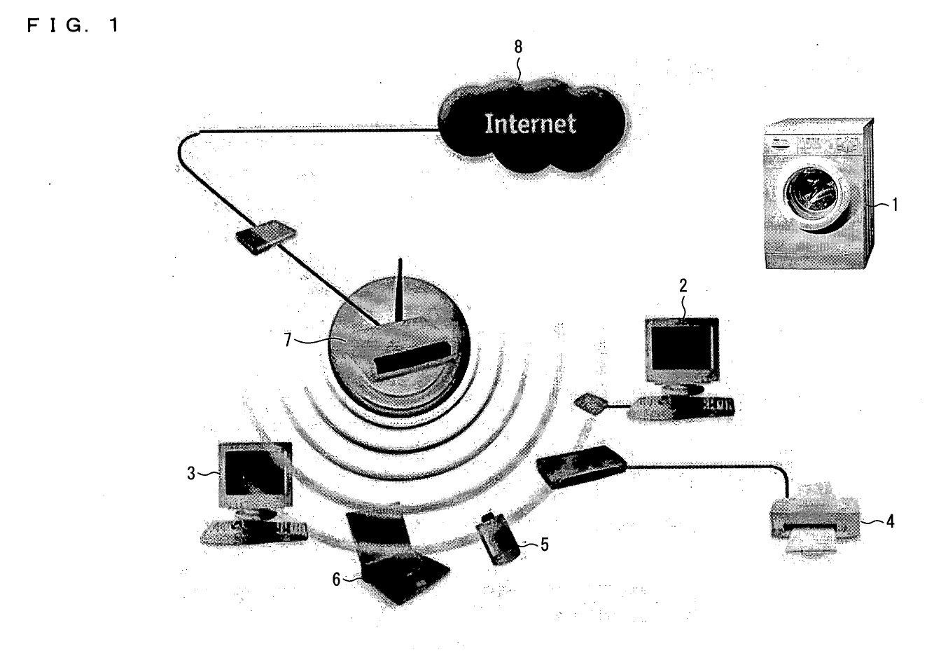

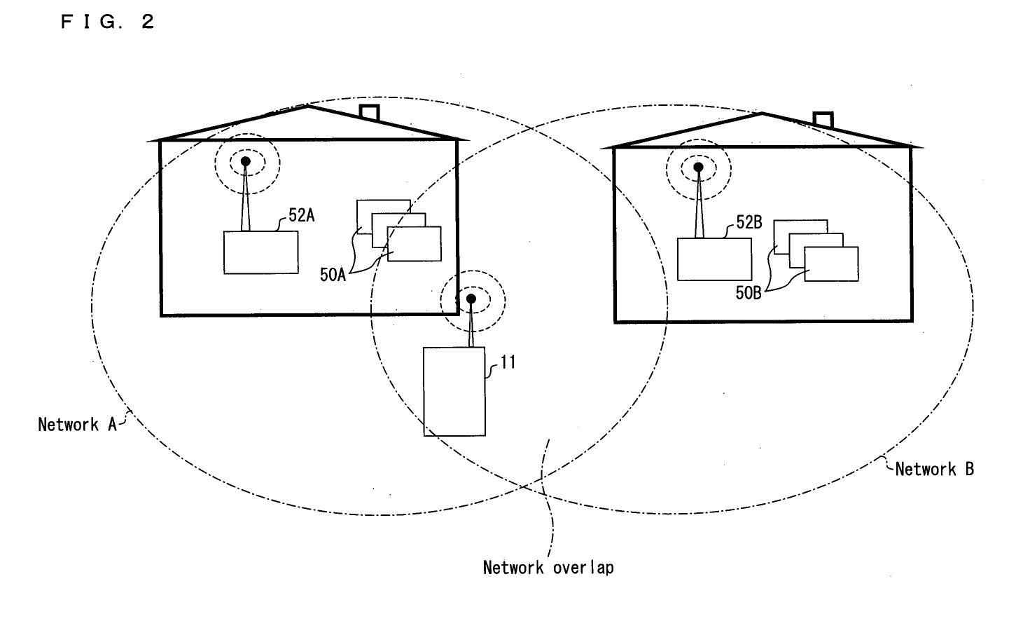

### BEST MODE FOR CARRYING OUT THE INVENTION

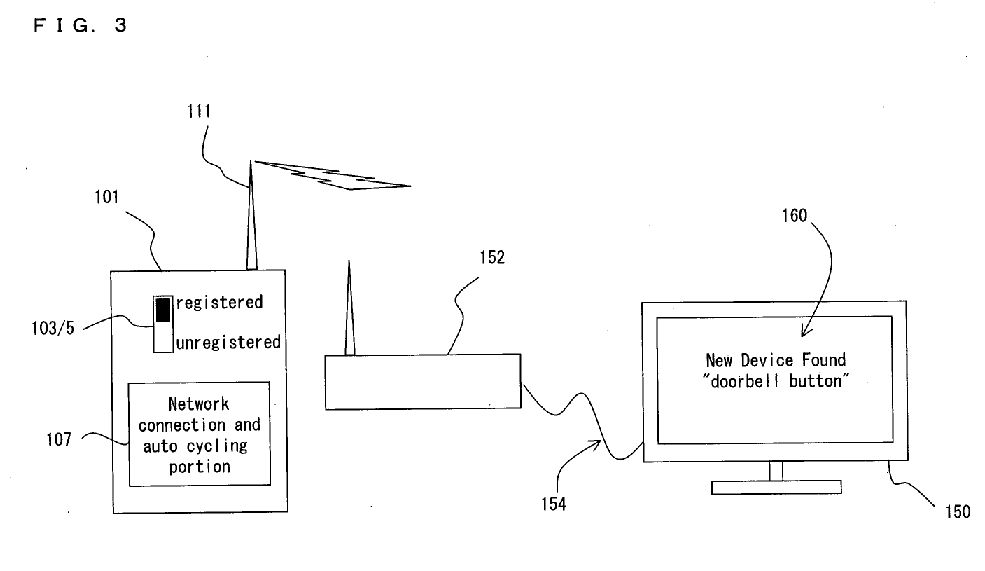

FIG. 3 is a block diagram illustrating a system according to a first embodiment of the present invention, comprising a limited user interface device 101, a network component 150 and a wireless access point 152. The wireless access point 152 is connected to the network component 150 by a logical connection 154, which may be wired or wireless. The limited user interface device 101 comprises a switch 103/5, a network connection and automatic cycling portion 107 and a wireless antenna 111. The network component 150 is adapted to display visual indications or messages such as the indication 160 illustrated in FIG. 3, and in the example illustrated in FIG. 3 is in the form of a display.

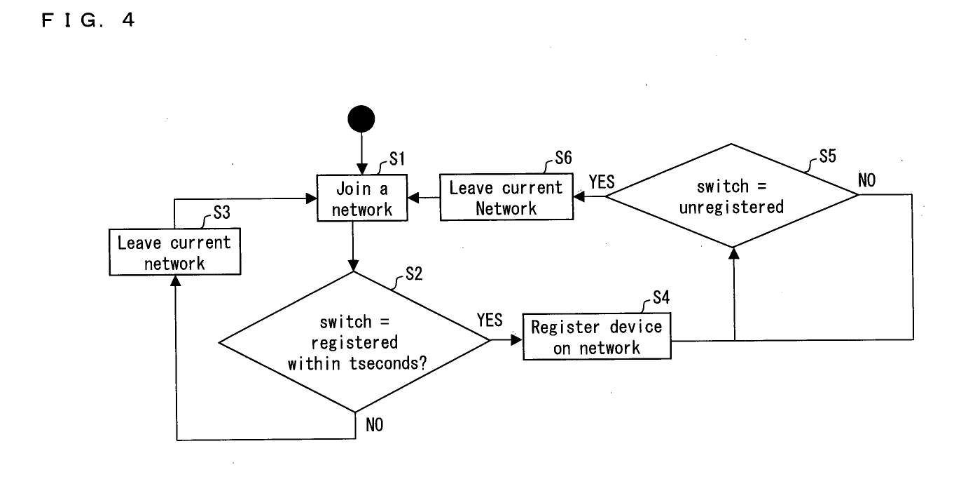

Operation of the first embodiment of the present invention will now be described with reference to the flowchart of FIG. 4. It is assumed that the limited user interface device 101 is within range of a plurality of available networks to which it is able to connect, and further it is assumed that the network component 150 is already connected to the particular network that a user of the device 101 wishes the device 101 to join. The device 101 is able to determine or compile a list of the available networks within range that it could reasonably join (for example those that do not require security credentials that the device 101 does not possess). The device 101 may have the ability to sort this list of available networks by some predefined metric (for example, signal strength, lexicographically by SSID, channel frequency, and so on), or the device 101 may simply leave the list disordered.

The device 101 has a user interface that is limited to the extent that the user interface does not allow direct selection by a user of the device 101 of the correct network from the list of available networks. To overcome the limited nature of the user interface at the device 101, a procedure as shown in FIG. 4 is followed by the device 101. In this procedure, which will be described in more detail below, the device 101 connects or attempts to connect to each of the available networks in turn until an indication is provided from the correct network confirming the connection or the connection attempt; once that indication has been provided, the device 101 is informed that it has found the correct network and need search no more.

In the first embodiment of the present invention, the switch 103/5 is moveable between a first (“unregistered”) state and a second (“registered”) state. When a new network is to be found, the switch 103/5 is moved to the first state, which indicates to the network connection and automatic cycling portion 107 that the device 101 is unregistered and that a new network needs to be found. This represents the entry point into the method of FIG. 4, beginning with step S1.

In step S1, the network connection and automatic cycling portion 107 causes the device 101 to join a first one of the available networks. The user watches the network component 150 for an indication 160 to appear on the display. If such an indication 160 does appear, then it confirms that the device 101 has joined or has attempted to join the correct network. The user then moves the switch 103/5 from the first state to the second state to inform the device that an appropriate indication 160 has been provided from the network component 150.

Returning to the flowchart of FIG. 4, step S1 represents the start of a predetermined period in which the user is able to actuate the switch 103/5 in the above-mentioned manner should an appropriate indication 160 be displayed at the network component 150. The state of the switch 103/5 is monitored in step S2, and if the switch is not moved to the “registered” (second) state within the predetermined period, then processing continues to step S3 in which the network connection and automatic cycling portion 107 causes the device 101 to leave the current network so that processing can return back to step S1 where a second one of the available networks can be tried. Therefore, if the switch 103/5 is left in the “unregistered” (first) state then a loop defined by steps S1 to S3 is set up in which the device tries each of the available networks in turn. After unsuccessfully trying every network on the available list, the device 101 can either start again from the top of the list of available networks (possibly reordering the list first), or can return to some dormant state, awaiting further intervention.

On the other hand, if it is determined in step S2 that the switch 103/5 has been moved to the “registered” (second) state, then processing proceeds to step S4 in which the existing connection is confirmed and the device 101 is registered on the network. Processing then continues to step S5 in which the state of the switch 103/5 is monitored. If it is determined in step S5 that the switch has not been moved to the “unregistered” state, then processing remains at step S5. If, on the other hand, it is determined in step S5 that the switch has been moved back to the “unregistered” state, then processing proceeds to step S6 in which the network connection and automatic cycling portion 107 causes the device 101 to leave the current network and to rejoin the loop defined by S1 to S3 as described above to try other networks.

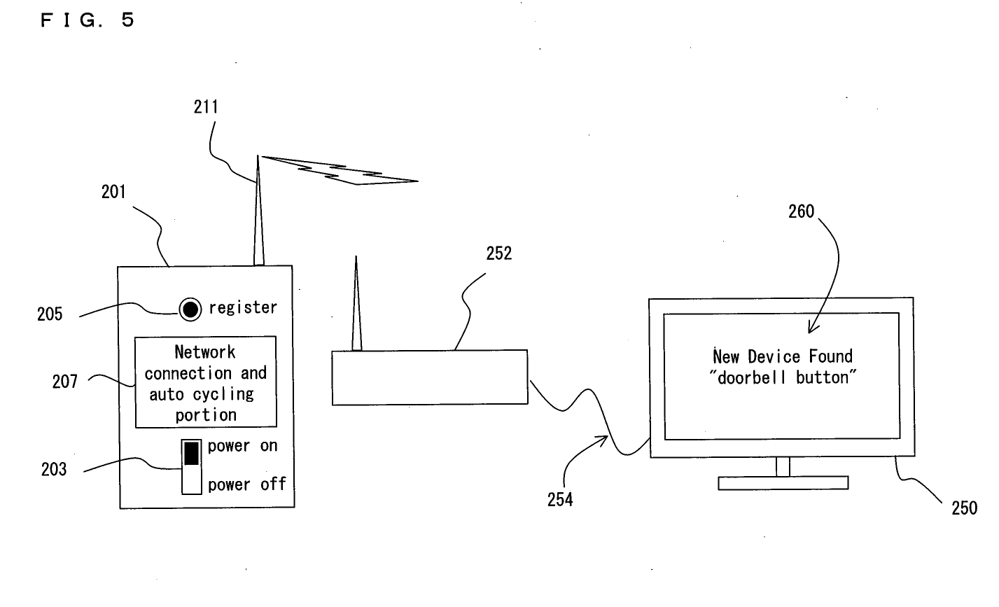

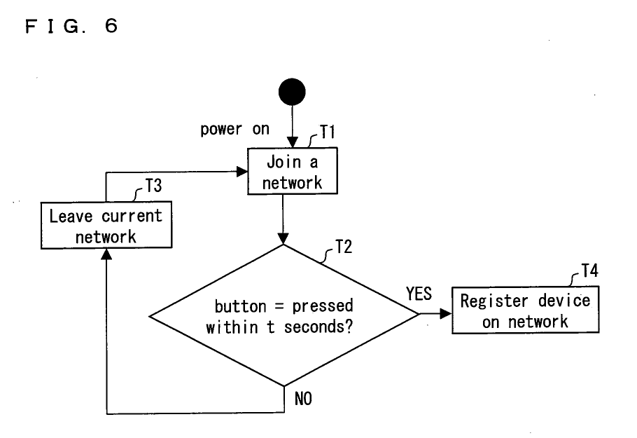

A second embodiment of the present invention will now be described with reference to FIGS. 5 and 6. The second embodiment is generally similar to the first embodiment, and so a detailed description will not be required. Those parts of FIG. 5 having a reference numeral differing only in the first digit from corresponding respective parts of FIG. 3 will generally have the same or similar function, unless otherwise described, as in the first embodiment, and the same applies with respect to the flowchart of FIG. 6 compared to the flowchart of FIG. 4.

A system according to the second embodiment of the present invention comprises a limited user interface device 201 and a network component 250 connected to a wireless access point 252 by a logical connection 254. The limited user interface 201 comprises a two-state power switch 203, a push button 205, a network connection and automatic cycling portion 207 and a wireless antenna 211. Illustrated in FIG. 5 is an indication 260 provided on the network component 250.

Whereas in the first embodiment the device 101 was prompted into cycling through the available networks by the switch 103/5 being moved from one state to another, in the second embodiment this cycling is initiated by moving the power switch 203 from a “power off” state to a “power on” state, i.e. when the device 201 is powered on.

Automatic cycling through the available networks is achieved by the loop created by steps T1 to T3 of FIG. 6 in the absence of any user action at the device 201. To enable the user to inform the device 201 when the indication 260 has been provided at the network component 250, the push button 205 is provided at the device 201, and on pressing the button 205 within the predetermined period, the loop T1 to T3 is broken so that processing can continue to step T4, from step T2, where the device 201 is registered on the network.

In the above-described second embodiment, the device 201 is caused to start trying each of the available networks in turn. Optionally, this could be made to happen only on the first occasion, if a separate ‘reset’ mechanism exists.

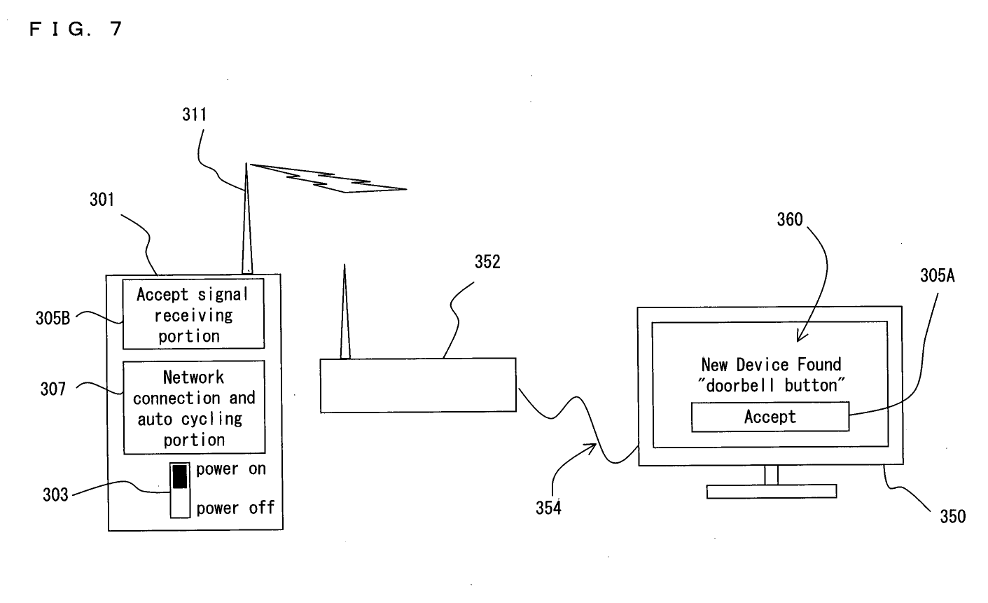

A third embodiment of the present invention will now be described with reference to FIGS. 7 to 9. The third embodiment comprises a limited user interface device 301 and a network component 350 connected by a logical connection 354 to a wireless access point 352. The limited user interface device 301 comprises a two-state power switch 303, a network connection and automatic cycling portion 307, an accept signal receiving portion 305B and a wireless antenna 311. Illustrated on the network component 350 is an indication 360 and a user interface accept button 305A.

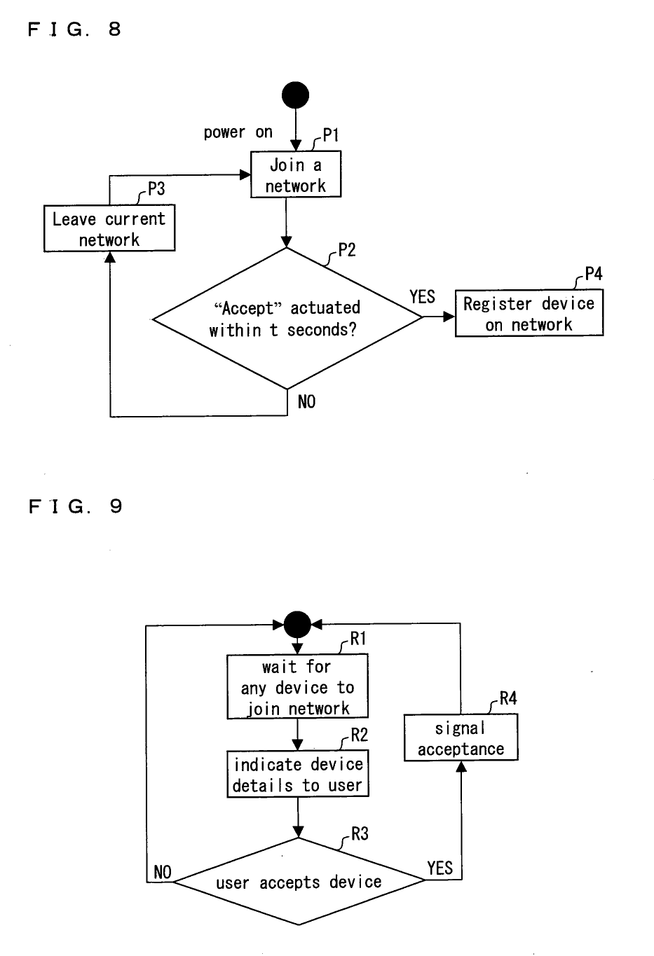

The third embodiment is generally similar to the second embodiment, with steps P1 to P4 of FIG. 8 corresponding generally to steps T1 to T4 respectively of FIG. 6. Those parts of FIG. 7 having a reference numeral differing only in the first digit from corresponding respective parts of FIG. 5 will generally have the same or similar function, unless otherwise described.

The main difference between the second and third embodiments is that, in the third embodiment, the user action to confirm to the device 301 that the correct network has been. reached is achieved at the network component 350 rather than at the device 301. For this purpose, the network component 350 is adapted to display a user interface button 305A together with the indication 360, and on pressing the user interface button 305A, an accept signal is sent wirelessly to the accept signal receiving portion 305B of the device 301, causing the loop consisting of steps P1 to P3 to be broken, and thereby enabling the device to be registered on the network in step P4.

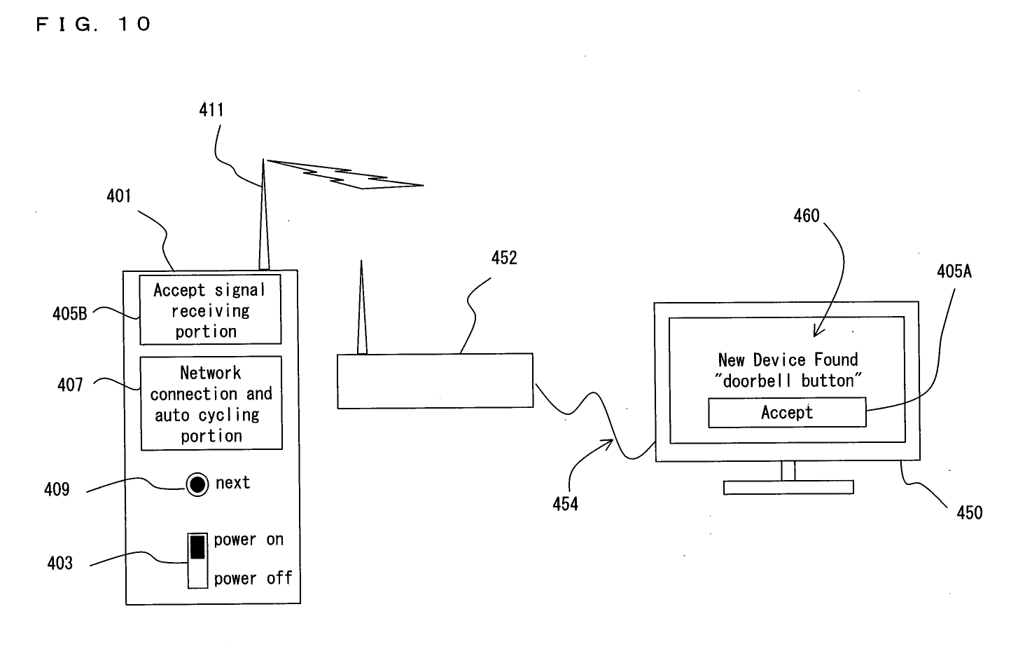

The method performed at the network component 350 is illustrated by the flowchart in FIG. 9. In step R1, the network component waits for any device to join the network. When a device does join, device details, providing an identification of the device, are indicated to the user by way of the indication 360 in step R2, along with the user interface button 305A. This indication confirms that the network has been reached by that particular device, rather than some other device, for example a rogue device. If it is determined in step R3 that the user has accepted the device, then the accept signal is sent in R4, with processing returning to step R1 to wait for a further device to join the network. If it is determined that the user does not accept the device in step R3, for example within a predetermined time period, then processing again returns to step R1 to await a further connection.

Therefore, it can be seen that the main difference between the third embodiment and the second embodiment is the replacement of the button 205 at the device 201 in the second embodiment with a user interface button 305A at the network component 350 in the third embodiment, together with an accept signal receiving portion 305B at the device 301.

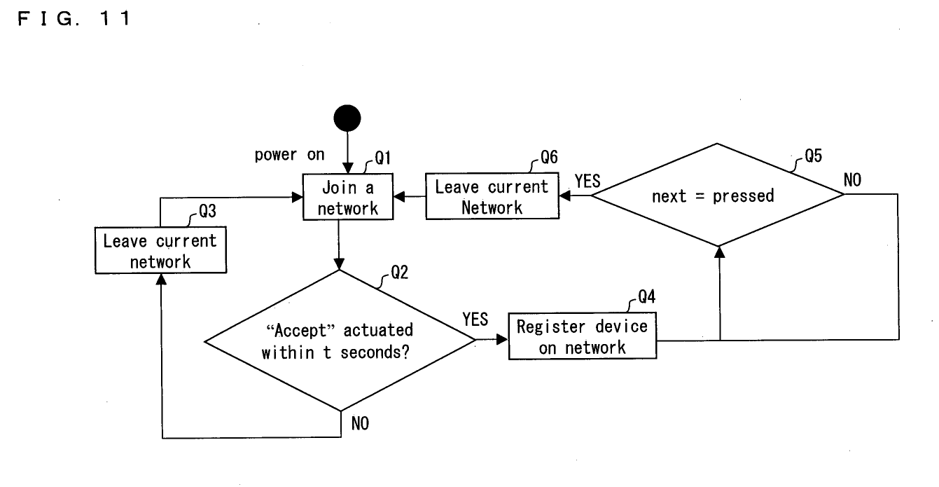

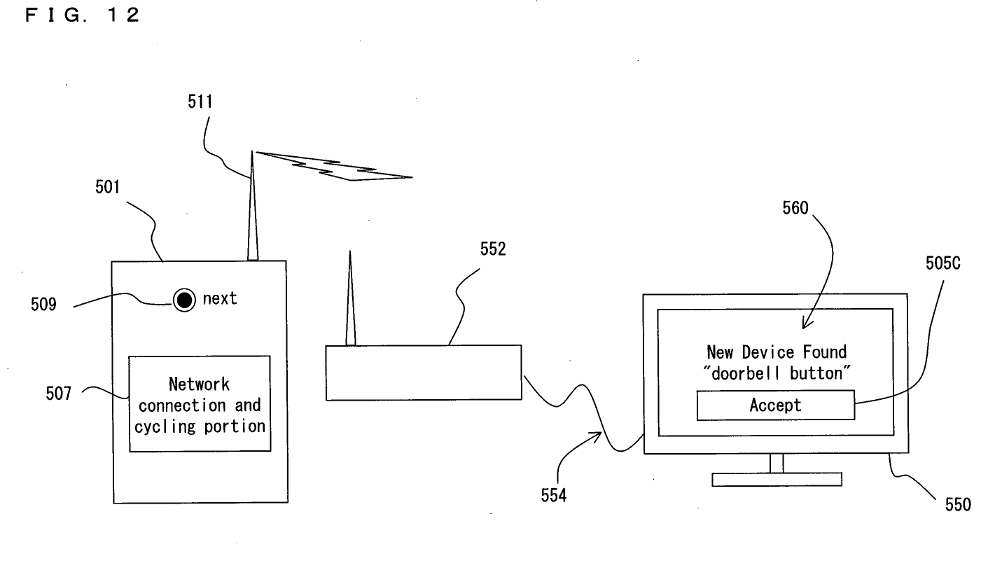

A fourth embodiment of the present invention will now be described with reference to FIGS. 10 and 11, with FIG. 9 also applying to this embodiment. The parts labelled 403, 405A, 405B, 407, 411, 450, 452, 454 and 460 are generally as described above with reference to those parts of FIG. 7 having respective reference numerals differing only in the first digit. Steps Q1 to Q4 also correspond generally to respective steps P1 to P4 of FIG. 8.

The fourth embodiment differs from the third embodiment in having a push button 409 at the device 401. The button 409 is provided to enable the user to force the device 401 to disconnect from the current network and continue its search through the list of available networks, and this is achieved by steps Q5 and Q6 shown in the flowchart of FIG. 11. This feature is beneficial where the device 401 is accepted onto the wrong network, either accidentally or maliciously by a third party.

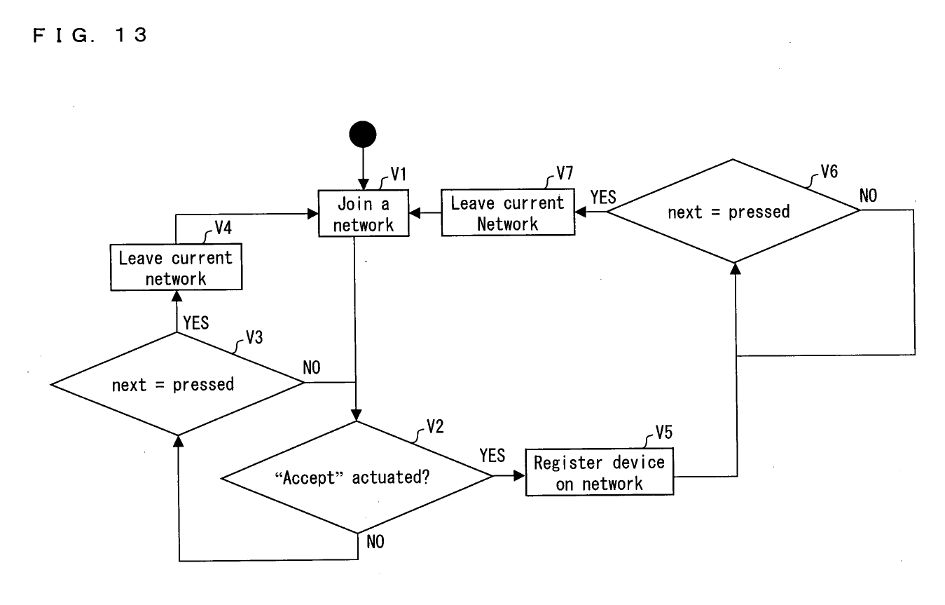

A fifth embodiment of the present invention will now be described with reference to FIGS. 12 and 13, with the flowchart of FIG. 9 also applying to this embodiment.

A system according to the fifth embodiment of the present invention comprises a limited user interface device 501 and a network component 550, with the network component 550 being connected to a wireless access point 552 by a logical connection 554. Illustrated on the network component 550 are an indication 560 and a user interface button 505C. The limited user interface device 501 comprises a network connection and cycling portion 517, a push button 509 and a wireless antenna 511.

The fifth embodiment differs from each of the first to fourth embodiments in that cycling through the list of available networks is achieved manually in the fifth embodiment, by use of the push button 509, rather than automatically.

When powered on, in step V1 the network connection and cycling portion 517 causes the device 501 to connect to the first available network in the list of networks. If it is determined in step V3 that the push button 509 has been actuated, then processing proceeds to V4 in which the network connection and cycling portion 517 causes the device 501 to disconnect from the current network, after which processing returns to step V1 for a new cycle in which the next available network is tried.

If it is determined in step V2 that the user interface button 505C has been actuated, then the device can be registered with the network in step V5. Following step V5, the state of the push button 509 is again monitored, in step V6, until it is determined that the push button 509 has been actuated, at which point the network connection and cycling portion 517 causes the device 501 to disconnect from the current network in step V7 so that a new cycle can be begun by returning to step V1.

It can be seen that, in the fifth embodiment, not only is the user required manually to cycle through the list of available networks until the correct network is found, but the step of registering the device with the network is separate from the step of actually connecting to or joining the network. This requirement for some form of confirmation from a network component before the device is officially registered with the network provides a further level of security. Generally, it would only be necessary for a user action to be made at one place in the system, not two, to confirm that the correct network has been found, and the fifth embodiment could be modified to work without the user interface button 505C. In the fifth embodiment, an implicit confirmation that the correct network has been found is provided by the mere act of leaving the device alone without pressing the ‘next’ button 509 any further.

In each of the above embodiments, it will be apparent that it is the human user that ultimately informs the limited user interface device, in some way or other, that the correct network has been found, and that this is in response to some sort of indication being provided from a component of the network.

It will be appreciated that the invention is not limited to the specific embodiments described above, and that the skilled person would readily be able to combine the various features of the above-described embodiments to achieve a method of connecting a device having a limited user interface to a predetermined one of a plurality of available networks, comprising trying each one of the available networks in turn from the device until an indication is provided from a component of a predetermined network in response to said trying that confirms that the predetermined network has been reached and; and in response to such an indication being provided, connecting the device to the predetermined network if not already so connected as part of said trying.

It will also be appreciated that embodiments of the present invention are not limited to using push button or sliding switches as described above. Other forms of user interface or user interaction would be readily apparent to the skilled person. Also, the switches and buttons in the above-described embodiments might not be dedicated controls, but might reuse existing interfaces on the appliance. For example, the ‘power on/off’ effect might be achieved by the act of inserting/removing batteries; the ‘next’ button for a doorbell push unit might make use of the ringer button itself; and the ‘next’ button on a washing machine might simply be one of the existing wash options buttons.

Likewise, the type of indication is not limited to visual indications or messages. Any effect that can be perceived by a user would be suitable, such as an audible indication. For example a new doorbell button may find and ring a doorbell buzzer already on the network. One or more light or sound signals could be used in order to convey further information, for example about the status of the device or the network.

It may also be that the indication is not provided automatically as part of the registration process, but may require some form of user actuation. For example, where a new doorbell button is searching for a network to which a doorbell buzzer is already connected, the doorbell buzzer may only provide an audible indication in response to the doorbell button being pressed.

Furthermore, in the above embodiments it is described that the indication is provided at the component already on the network, for example in the form of a message displayed on the screen of a network component. It may also be that such an indication is an electronic indication, not readily perceivable by the user. The electronic indication may be sent onward to another device, even to the limited user interface device itself, and a secondary indication (e.g. visible or audible) may be provided in response to receipt of such an electronic indication that can be used confirm that the correct network has been reached. For example, the limited user interface device could be made to play a ‘signature’ tune known by the user to be associated with the network that the device is attempting to join.

Although the above embodiments describe a method in which each available network is joined in turn until the correct network is confirmed, it will be appreciated that it is not necessary actually to join the network in each cycle. For example, merely trying to join, or polling, would be sufficient. The sending of some sort of message or signal from the limited user interface device that identifies or relates in some way to the network in question, and which would allow a component of that network to recognise this and to provide an indication that the device is reaching out to the correct network, would be sufficient. Once such an indication is provided, and this is communicated in some way to the limited user interface device, the device could then connect to the network. Some sort of ‘hailing channel’ could be used for this purpose, with a communications channel only being established after the correct network is identified.

If encryption or other security is required over the network being joined, then this could be implemented at a higher layer of the protocol stack.

Although the above embodiments of the present invention have been described in relation to wireless networks, it will be appreciated that the present invention can be applied to other types of network, such as powerline networks. In fact, the present invention can be applied to any type of open network having a range that might reach several separate environments.

Although a device is described above that is generally capable only of providing a limited user interface, the present invention is also applicable to a situation where a device is actually capable of providing a rich and complex user interface, but chooses to present only a limited user interface to the user for the purpose of connecting the device to a network. Such a device would also be considered to have a limited user interface, since the user interface can be considered to be that which is presented to the user specifically in relation to the connecting of the device. In addition, it will be appreciated that, although the user interface described above in relation to the various embodiments comprises a physical interface, the user interface may also comprise a graphical interface, as well as or instead of a physical interface.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method of connecting a device having a limited user interface to a predetermined one of a plurality of available networks, comprising trying each of the available networks in turn from the device until an indication is provided from a component of the predetermined network in response to said trying that confirms that the predetermined network has been reached; and, in response to such an indication being provided, connecting the device to the predetermined network if not already so connected as part of said trying.

2. A method as claimed in claim 1, wherein trying each of the available networks in turn from the device comprises connecting or attempting to connect the device to each of the available networks in turn.

3. A method as claimed in claim 1, wherein trying each of the available networks in turn from the device comprises polling each network in turn.

4. A method as claimed in claim 1, comprising automatically moving on to the next network in turn unless the device is informed, within a predetermined time period or before a predetermined event occurs, that such an indication has been provided.

5. A method as claimed in claim 4, wherein the predetermined time period is measured relative to the commencement of said trying.

6. A method as claimed in claim 4, wherein the predetermined event is a user action performed for example at the device.

7. A method as claimed in claim 1, comprising providing interface means at the device for allowing a user to inform the device that such an indication has been provided.

8. A method as claimed in claim 1, comprising providing interface means at the device for allowing the user to move the device on to the next network in turn.

9. A method as claimed in claim 7, wherein the interface means comprise a sliding type switch.

10. A method as claimed in claim 7, wherein the interface means comprise a push-button type switch.

11. A method as claimed in claim 1, comprising providing means at the device for receiving a signal over a network informing the device that such an indication has been provided.

12. A method as claimed in claim 11, comprising receiving such a signal over the predetermined network.

13. A method as claimed in claim 11, comprising providing interface means at a component of the predetermined network for allowing a user to confirm that such an indication has been provided, and, in response to such user confirmation, sending such a signal to the device.

14. A method as claimed in claim 1, comprising registering the device with the predetermined network.

15. A method as claimed in claim 13, comprising registering the device with the predetermined network only when such user confirmation has been provided.

16. A method as claimed in claim 1, wherein such an indication provides an identification of the device, thereby confirming that the predetermined network has been reached by the device.

17. A method as claimed in claim 1, wherein such an indication comprises a visual indication.

18. A method as claimed in claim 1, wherein such an indication comprises an audio indication.

19. A method as claimed in claim 1, wherein such an indication comprises an electronic indication, and comprising providing a secondary indication in response to receipt of such an electronic indication that confirms that the predetermined network has been reached.

20. A method as claimed in claim 19, comprising providing such a secondary indication at the device.

21. A method as claimed in claim 1, wherein the user interface of the device is limited to the extent that it does not allow direct selection by a user of the device of the predetermined network from a list of the available networks.

22. A method as claimed in claim 1, wherein the user interface is that which is presented to the user in relation to the connecting of the device.

23. A method as claimed in claim 1, wherein the user interface comprises a physical interface.

24. A method as claimed in claim 1, wherein the user interface comprises a graphical interface.

25. A method as claimed in claim 1, wherein the predetermined network is a wireless or a powerline network.

26. A device having the ability to connect to a predetermined one of a plurality of available networks despite having a limited user interface, comprising means for trying each of the available networks in turn until an indication is provided from a component of the predetermined network in response to said trying that confirms that the predetermined network has been reached; and, in response to the indication being provided, connecting the device to the predetermined network if not already connected as part of said trying.

27.-30. (canceled)

31. An apparatus programmed by a program for controlling said apparatus to perform a method as claimed in claim 1.

32. A storage medium containing a program for controlling an apparatus to perform a method as claimed in claim 1.
